(19) United States
(12) Patent Application Publication
(10) Pub. No.: US 2020/0134693 A1
(43) Pub. Date: Apr. 30, 2020

(54) METHOD, DEVICE AND EQUIPMENT FOR RECOMMENDING PRODUCT, AND COMPUTER READABLE STORAGE MEDIUM

(71) Applicant: Ping An Technology (Shenzhen) Co., Ltd., Shenzhen, Guangdon (CN)

(72) Inventor: Jialin Ding, Shenzhen, Guangdong (CN)

(73) Assignees: Ping An Technology (Shenzhen) Co., Ltd., Shenzhen, Guangdong (CN); Ping An Technology (Shenzhen) Co., Ltd., Shenzhen, Guangdong (CN)

(21) Appl. No.: 16/305,887

(22) PCT Filed: Feb. 11, 2018
(86) PCT No.: PCT/CN2018/076196

§ 371 Date: Nov. 29, 2018

(30) Foreign Application Priority Data
Jun. 20, 2017 (CN) 201710474485.1

(51) Int. Cl. G06Q 30/06; G06Q 40/06

(52) U.S. Cl. CPC G06Q 30/0631; G06Q 40/06

(57) ABSTRACT

Disclosed is a method, a device and an equipment for recommending product, the method includes the following steps: when a trigger instruction of recommending a product to be recommended is detected, acquiring an operating data of a customer who has already purchased the product to be recommended according to the trigger instruction; calculating a predicted score of purchasing the product again for the customer to purchase the product to be recommended according to the operating data; and if the predicted score is higher than a preset score, recommending the product to be recommended to the customer. The present disclosure realizes that the predicted score of purchasing the product again for the customer to purchase the product to be recommended is calculated according to the operating data, and whether the product to be recommended is recommended to the customer is determined according to the predicted score.

The present application claims the benefit of China Patent Application No. 201710474485.1, filed Jun. 20, 2017, with the State Intellectual Property Office and entitled “METHOD AND APPARATUS FOR RECOMMENDING PRODUCT, AND COMPUTER READABLE STORAGE MEDIUM”, the entirety of which is hereby incorporated herein by reference.

### FIELD

This disclosure generally relates to the technical field of internet, and more particularly relates to a method and a device for recommending product, an apparatus for recommending product, and a computer readable storage medium.

### BACKGROUND

With the rapid development of internet, various kinds of application softwares always recommend products to customers to improve the products' sales rate. However, currently, the product recommending are normally focus on new customers, and the method to recommend products are normally based on advertising, it means that, the customers need to voluntarily discover the products, and purchase the product.

After having been successfully purchased a product, for example, an insurance product or a financial product, the customer would no longer pay attention to the product again. For the products which need to be renewed, if the customer does not receive a corresponding product recommending information when the products have expired, the customer may not purchase the product again, or forget to purchase the product again. As a result, the purchasing rate of the products would be low, as well as the renewal rate of the renewed products.

### SUMMARY

It is therefore one main object of this disclosure to provide a method and a device for recommending product, an apparatus for recommending product, and a computer readable storage medium, aiming to solve the technical problem of low purchasing rate of the product, and low renewal rate of the renewed product.

In order to achieve the above object, the method for recommending product proposed by this disclosure includes the following steps:

when a trigger instruction of recommending a product to be recommended is detected, acquiring an operating data of a customer who having already purchased the product to be recommended according to the trigger instruction;

calculating a predicted score of purchasing the product again for the customer to purchase the product to be recommended according to the operating data; and

recommending the product to be recommended to the customer if the predicted score is higher than a preset score.

In addition, in order to achieve the above object, the present disclosure also provides a device for recommending product, which includes:

an acquiring module, configured to, when a trigger instruction of recommending a product to be recommended is detected, acquire an operating data of a customer who having already purchased the product to be recommended according to the trigger instruction;

a calculating module, configured to calculate a predicted score of purchasing the product again for the customer to purchase the product to be recommended according to the operating data; and

a recommending module, configured to, if the predicted score is higher than a preset score, recommending the product to be recommended to the customer.

In addition, in order to achieve the above object, the present disclosure also provides an apparatus for recommending product, which includes a memory, a processor, and a program for recommending product stored in the memory and operated by the processor, the program for recommending product performs the steps in the method for recommending product when is executed by the processor.

In addition, in order to achieve the above object, the present disclosure also provides a computer readable storage medium, which includes a program for recommending product, the program for recommending product performs the steps in the method for recommending product when is executed by processor.

When the trigger instruction of recommending product to be recommended is detected, the operating data of the customer who has already purchased the product to be recommended is acquired according to the trigger instruction; the predicted score of purchasing the product again for the customer to purchase the product to be recommended is calculated according to the operating data; if the predicted score is higher than the preset score, the product to be recommended is recommended to the customer. The present disclosure realizes that the predicted score of purchasing the product again for the customer to purchase the product to be recommended is calculated according to the operating data, and whether the product to be recommended is recommended to the customer is determined according to the predicted score, such improving the purchasing rate of the product to be recommended; and for the product needs to be renewed, the method also improves the renewal rate of the renewed product.

### BRIEF DESCRIPTION OF THE DRAWINGS

FIG. 1 is a structure diagram of the device in hardware operating environment of the present disclosure according to an exemplary embodiment;

FIG. 2 is a flow chart of the method for recommending product of the present disclosure according to the first exemplary embodiment.

FIG. 3 is a flow chart of the method for recommending product of the present disclosure according to the second exemplary embodiment.

FIG. 4 is a flow chart of the step of recommending the product to be recommended to the customer if the predicted score is higher than a preset score, according to an exemplary embodiment of the present disclosure.

The realization of the aim, functional characteristics, advantages of the present disclosure are further described specifically with reference to the accompanying drawings and embodiments.

### DETAILED DESCRIPTION

It is to be understood that, the described embodiments are only some exemplary embodiments of the present disclosure, and the present disclosure is not limited to such embodiments.

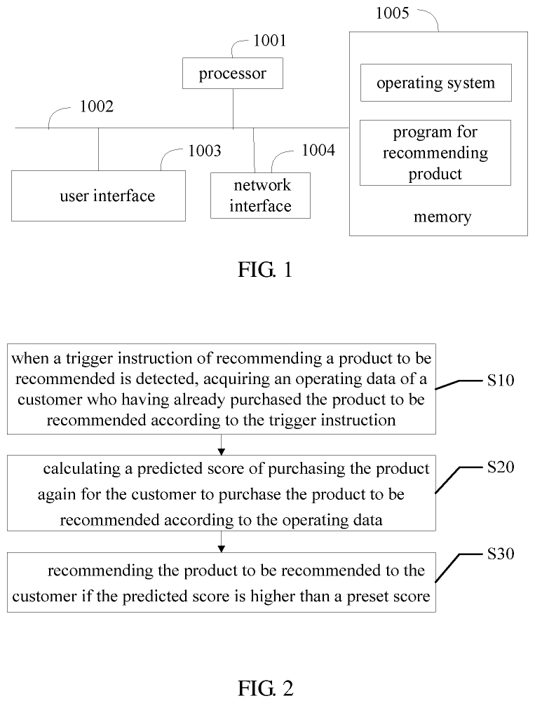

Referring to FIG. 1, FIG. 1 is a structure diagram of the device in hardware operating environment of the present disclosure according to an exemplary embodiment.

In an exemplary embodiment of the present disclosure, the device for recommending product can be a personal computer (PC), or a portable terminal apparatus, such as, a smart-phone, a tablet personal computer, an ebook reader, or a MP3 (Moving Picture Experts Group Audio Layer III) player, a portable computer, etc.

Referring to FIG. 1, the device for recommending product includes: a processor 1001, such as CPU (Central Processing Unit), a network interface 1004, a user interface 1003, a memory 1005, and a communication bus 1002. The communication bus 1002 is configured to realize the connecting and communicating among the above components. The user interface 1003 can include a display, an input unit, such as a keyboard, selectively, the user interface 1003 can also include a standard wired interface, wireless interface. Selectively, the network interface 1004 can include a standard wired interface, wireless interface (such as, a WI-FI interface). The memory 1005 can be a high speed RAM memory, or a non-volatile memory, such as, a magnetic disc memory. Selectively, the memory 1005 can be a storage device which is independent of the processor 1001.

Selectively, the device for recommending product also includes a camera, a RF (Radio Frequency) circuit, a sensor, an audio circuit, a WIFI module, etc.

The persons skilled in the art can understand that, the structure of device for recommending product shown in FIG. 1 cannot be used for limiting the terminal, and can include more or less parts, or include combination of some of the parts, or include different configuration of parts.

Referring to FIG. 1, the memory 1005, which can be defined as a computer storage medium, can include an operating system and a program for recommending product. The operating system is defined as a program for managing and controlling the hardware and software resources of the device for recommending product, and supporting the program for recommending product, and the operating of other software and/or other program.

In the device for recommending product shown in FIG. 1, the network interface 1004 is mainly configured to connect with the user held terminal, and communicate with the user held terminal; the user interface 1003 is mainly configured to receive and acquire the instruction, etc. And the processor 1001 is configured to call the program for recommending product stored in the memory 1005, and perform the steps of the method for recommending product.

The detail exemplary embodiments of the device for recommending product are substantially the same with the exemplary embodiments of the method for recommending product, no need to repeat again.

The exemplary embodiments of the method for recommending product are provided based on the above hardware structure.

Referring to FIG. 2, FIG. 2 is a flow chart of the method for recommending product of the present disclosure according to the first exemplary embodiment.

In the exemplary embodiment, a method for recommending product is provided, it should be noted that, although the flow chart shows the logical order, while in some cases, the steps can be performed in a different order.

The method for recommending product includes:

Step S10, when a trigger instruction of recommending a product to be recommended is detected, acquiring an operating data of a customer who having already purchased the product to be recommended according to the trigger instruction.

When the device for recommending product detects the trigger instruction of recommending the product to be recommended, acquires the operating data of the customer who has already purchased the product to be recommended according to the trigger instruction. In detail, when the device for recommending product detects the trigger instruction, the processor 1001 of the device for recommending product acquires the operating data of the customer who has already purchased the product to be recommended from the memory 1005 according to the trigger instruction. The operating data includes, but is not limited to, a focus frequency of the customer to each product to be recommended in the application, a payment data of each product in the application, a payment data corresponding to the purchased product, and click times of the product to be recommended.

In the exemplary embodiment of the present disclosure, the trigger instruction can be automatically triggered by the device for recommending product, or can also be triggered by worker. When the trigger instruction is automatically triggered by the device for recommending product, a timed task can be set in the device for recommending product (such as, the trigger instruction can be triggered at a regular time every day, or triggered after a certain interval), when the condition of the timed task is fulfilled, the device for recommending product automatically triggers the trigger instruction. Furthermore, in the exemplary embodiment, successfully purchasing the product indicates that the customer has already purchased the product to be recommended, and has already paid the fee corresponding to the product to be recommended.

Step S20, calculating a predicted score of purchasing the product again for the customer to purchase the product to be recommended according to the operating data.

Step S30, recommending the product to be recommended to the customer if the predicted score being higher than a preset score.

After acquiring the operating data of the customer, the predicted score of purchasing the product again for the customer to purchase the product to be recommended is calculated according to the operating data, whether the predicted score is higher than the preset score is determined. When the predicted score is higher than the preset score, the product to be recommended is recommended to the customer according to the preset rule; when the predicted score is smaller than or equal to the preset score, the product to be recommended shall not be recommended to the customer.

Furthermore, the Step S20 further includes:

Step a, respectively calculating predicted sub scores corresponding to the focus frequency, the payment data, the payment data and the click times according to corresponding preset rules, based on the focus frequency, the payment data, the payment data and the click times.

Step b, determining weights of the focus frequency, the payment data, the payment data and the click times.

Step c, calculating the predicted score of purchasing the product again for the customer to purchase the product to be recommended according to the predicted sub scores and the weights.

The weight of the focus frequency is 0.25, the weight of the payment data is 0.2, the weight of the payment data is 0.25, the weight of the click times is 0.3, when the predicted sub score of the focus frequency is recorded as A, the predicted sub score of the payment data is recorded as B, the predicted sub score of the payment data is recorded as C, the predicted sub score of the click times is recorded as D, the predicted score is recorded as S, then S=A*0.25+B*0.2+C*0.25+D*0.3.

Furthermore, when the focus frequency, the payment data, the payment data and the click times are acquired, the predicted sub score corresponding to the focus frequency is calculated according to the preset rule corresponding to the focus frequency, the predicted sub score corresponding to the payment data is calculated according to the preset rule corresponding to the payment data, the predicted sub score corresponding to the payment data is calculated according to the preset rule corresponding to the payment data, the predicted sub score corresponding to the click times is calculated according to the preset rule corresponding to the click times.

When the predicted sub scores corresponding to the focus frequency, the payment data, the payment data and the click times are acquired, the weights of the focus frequency, the payment data, the payment data and the click times in calculating the predicted scores are determined, the predicted score of purchasing the product again for the customer to purchase the product to be recommended is calculated according to the predicted sub scores and the weights corresponding to the focus frequency, the payment data, the payment data and the click times.

It should be noted that, the weights of the focus frequency, the payment data, the payment data and the click times in calculating the predicted scores can be set according to the requirement, in the exemplary embodiment, the weight ratio of the focus frequency, the payment data, the payment data and the click times is 5:4:5:6. As the unit of the predicted score is a hundred-mark system, so, the weight of the focus frequency is 0.25, the weight of the payment data is 0.2, the weight of the payment data is 0.25, the weight of the click times is 0.3. When the predicted sub score of the focus frequency is recorded as A, the predicted sub score of the payment data is recorded as B, the predicted sub score of the payment data is recorded as C, the predicted sub score of the click times is recorded as D, the predicted score is recorded as S, then S=A*0.25+B*0.2+C*0.25+D*0.3.

In the exemplary embodiment, the operating data includes a focus frequency of the customer to the product in the application, a payment data of the product in the application, a payment data corresponding to the purchased product, and click times of the product to be recommended. The focus frequency refers to the number of days that the customer has operated the product in the application; the payment data of the product in the application refers to total amount of the purchased products in the application; the payment data includes total payment times and missed payment times; the click times refer to the number of days that the customer has clicked the content related to the product to be recommended in the application. It should be noted that, during the process of acquiring the focus frequency and the click times, in order to reduce the calculating amount, the focus frequency and the click times in a set time period are acquired, for example, the focus frequency and the click times in the set time period from the now to last six months. In the exemplary embodiment, the focus frequency and the click times are calculated by day, that is, no matter how many times the customer has operated the product in the application on the same day, the focus frequency is recorded as one, also no matter how many times the customer has clicked the content related to the product to be recommended on the same day, the focus frequency is also recorded as one. In another exemplary embodiment, the units of the focus frequency and the click times can be set as hour, or the calculating unit can be set as the customer's operating frequency.

It should be noted that, the preset score can be set according to the requirement, in the exemplary embodiment, the related score adopts the hundred-mark system, for example, the preset score can be set as 60, 65, etc, in another exemplary embodiment, the related score can also not adopt the hundred-mark system. There is one preset mode, or multiple preset modes, the preset mode includes, but is not limited to, message, email, and we-chat. In the exemplary embodiment, each operating data corresponds to one preset rule, the preset rules for different operating datum are different, during the process of calculating the predicted score, the predicted sub score corresponding to the operating data can be calculated through the preset rule corresponding to the operating data, and then the predicted score can be obtained according to the predicted sub score.

Furthermore, the method for recommending product further includes:

Step d, when a login operation of logining into a corresponding application for purchasing the product to be recommended is detected, detecting a clicking operation of the customer applied on the product in the application.

Step e, acquiring the operating data of the customer operating the product in the application according to the clicking operation, and storing the operating data.

Furthermore, in the exemplary embodiment, the application platform of the product to be recommended can be merchant's application, that is, the device for recommending product is provided with the application corresponding to the product to be recommended. When the login operation of logining into the corresponding application for purchasing the product to be recommended is detected, the clicking operation of the customer applied on the product in the application is detected, and the operating data of the customer operating the product in the application is acquired according to the clicking operation, and then the operating data is stored. When the clicking operation of the customer applied on the product in the application is determined, the time of determining the clicking operation is recorded, then the time and the corresponding operating data can be stored together.

Furthermore, the step of calculating the predicted sub score corresponding to the payment data according to the preset rule corresponding to the payment data, based on the payment data, includes:

Step f, calculating a difference value between total payment times and missed payment times in the payment data; and

Step g, calculating the predicted sub score corresponding to the payment data according to the difference value and the total payment times.

Furthermore, based on the payment data, the detail process of calculating the predicted sub score corresponding to the payment data according to the preset rule corresponding to the payment data includes: the difference value between total payment times and missed payment times in the payment data is calculated, the predicted sub score C corresponding to the payment data is calculated according to the difference value and the total payment times. If the difference value is recorded as c1, the total payment times is recorded as c2, the predicted sub score C=c1/c2*c3+c4, in the exemplary embodiment, in order to ensure that the predicted sub score is presented in the form of the hundred mark system, c3=c4=50. While in another exemplary embodiment, c3 and c4 can be set to other values, and c3 can be equal to c4, or not equal to c4.

Furthermore, the preset rule corresponding to the focus frequency can be: when the focus frequency n1 is smaller than a1, A=A1; when a1≤n1<a2, A=A1+(n1−a1−1)*T1/(a2−a1); when n1≥a2, A=100. n1 refers to the focus frequency within the previous six months; T1 refers to a correlation coefficient for calculating the predicted sub score corresponding to the focus frequency, in order to ensure the predicted sub score is presented in the form of the hundred mark system, T1 should be smaller than 50, in the exemplary embodiment, T1=49.88. When a1=10, a2=100, A1=50, n1=69, the predicted sub score A corresponding to the focus frequency is equal to 83.25 (in the exemplary embodiment, the value of the predicted sub score should have up to two digits after the decimal point).

The preset rule corresponding to the payment amount can be: when the payment amount n2 is smaller than or equal to b1, B=B1; when b1<n2<b2, B=B1+(n2−b1)*T2/(b2−b1); when n2≥ b2, B=100. n2 refers to the payment amount of the purchased products in the application, the unit is yuan; T2 refers to a correlation coefficient for calculating the predicted sub score corresponding to the payment amount, in order to ensure the predicted sub score is presented in the form of the hundred mark system, T2 should be smaller than 50, in the exemplary embodiment, T2=49.88. For example, when b1=1000, b2=500000, B1=50, n2=50000, the predicted sub score corresponding to the payment score is recorded as B, B=50+(50000−1000)*49.88/(500000−1000)=54.99 (in the exemplary embodiment, the value of the predicted sub score should have up to two digits after the decimal point).

The preset rule corresponding to the click times can be: when the click times n3 are smaller than d1, D=D1; when d1<n3<d2, D=D1+(n3−d1)*T3/(d2−d1), when n3≥ d2, D=100. n3 refers to the click times within the last six mounts; T3 refers to a correlation coefficient for calculating the predicted sub score corresponding to the click times, in order to ensure the predicted sub score is presented in the form of the hundred mark system, T3 should be smaller than 50, in the exemplary embodiment, T3=49.88. For example, when d1=5, d2=15, D1=50, n3=12, the predicted sub score corresponding to the click times is recorded as D, D=50+(12−5)*49.88/(15−5)=84.92 (in the exemplary embodiment, the value of the predicted sub score should have up to two digits after the decimal point).

It should be noted that, in the exemplary embodiment, the vales corresponding to T1, T2 and T3 can be the same, or different.

When the trigger instruction of recommending product to be recommended is detected, the operating data of the customer who has already purchased the product to be recommended is acquired according to the trigger instruction; the predicted score of purchasing the product again for the customer to purchase the product to be recommended is calculated according to the operating data; if the predicted score is higher than the preset score, the product to be recommended is recommended to the customer. The predicted score of purchasing the product again for the customer to purchase the product to be recommended is calculated according to the operating data is realized, and whether the product to be recommended is recommended to the customer is determined according to the predicted score, such improving the purchasing rate of the product to be recommended, and avoiding recommending the product to be recommended to the customer with low purchasing rate; and for the product need to be renewed, the method also improves the renewal rate of the renewed product.

Furthermore, the method for recommending product according to the second exemplary embodiment is provided.

Referring to FIG. 3, the different between the method for recommending product according to the second exemplary and the method for recommending product according to the first exemplary is the method for recommending product further includes:

Step S40, acquiring a focused product of the customer, and determining a similarity between the focused product and the product to be recommended.

Step S20 includes:

Step S21, the predicted score of purchasing the product again for the customer to purchase the product to be recommended is calculated according to the similarity and the operating data.

The focused product of the customer is acquired, the similarity between the focused product and the product to be recommended is determined, and the predicted score of purchasing the product again for the customer to purchase the product to be recommended is calculated according to the similarity and the operating data. In detail, when the similarity between the focused product and the product to be recommended is calculated, the similarity between the focused product and the product to be recommended is calculated according to the main factors considered by customer when purchasing. Such as, when the product to be recommended is a financial product, the similarity between the focused product and the product to be recommended is calculated according to a financial cycle, a risk degree, a product type, and a yield rate.

When the similarity between the focused product and the product to be recommended, and the predicted sub score corresponding to the operating data are determined, the weight corresponding to the similarity and each operating data is determined, the predicted score of purchasing the product again for the customer to purchase the product to be recommended is calculated according to the similarity, the predicted sub score and the weight corresponding to each operating data. For example, it can be set as that S=A*a0+B*b0+C*c0+D*d0+E*e0, E refers to the similarity between the focused product and the product to be recommended, a0 refers to the weight of the focus frequency, b0 refers to the weight of the payment data, c0 refers to the weight of the payment data, d0 refers to the weight of the click times. It should be noted that, the ratio among a0, b0, c0, d0 and e0 can be set according to the requirement.

Furthermore, in the exemplary embodiment, the similarity can be defined as a calculating factor for calculating the predicted score. In another exemplary embodiment, the similarity can be defined as the weights for calculating the predicted scores corresponding to the focus frequency, the payment data, the payment data and the click times.

Furthermore, it can be set as that when the similarity is higher than or equal to the preset similarity, the similarity can be defined as the calculating factor of the predicted score; when the similarity is smaller than the preset similarity, the similarity cannot be defined as the calculating factor of the predicted score. The preset similarity can be set according to the requirement, for example, in the exemplary embodiment, the preset similarity can be set to 50%.

When the focused product and the product to be recommended are both financial products, the step S40 includes:

Step h, acquiring the focused product of the customer, and acquiring a financial cycle, a risk degree, a product type, and a yield rate of the focused product.

Step i, respectively comparing the financial cycle, the risk degree, the product type, and the yield rate of the focused product with a financial cycle, a risk degree, a product type, and a yield rate of the product to be recommended, to determine the similarity between the focused product and the product to be recommended.

Furthermore, when the focused product and the product to be recommended are both financial products, the financial cycle, the risk degree, the product type, and the yield rate of the focused product are acquired, the financial cycle, the risk degree, the product type, and the yield rate of the focused product are respectively compared with the financial cycle, the risk degree, the product type, and the yield rate of the product to be recommended, to determine the similarity between the focused product and the product to be recommended.

In detail, in the exemplary embodiment, the similarity W=M*m1+N*n1+P*p1+Q*q1. M refers to the similarity score of financial cycle, N refers to the similarity score of the risk degree, P refers to the similarity score of the product type, Q refers to the similarity score of the yield rate, m1 refers to the weight of the financial cycle when calculating the similarity between the focused product and the product to be recommended, n1 refers to the weight of the risk degree when calculating the similarity between the focused product and the product to be recommended, p1 refers to the weight of the product type when calculating the similarity between the focused product and the product to be recommended, q1 refers to the weight of the yield rate when calculating the similarity between the focused product and the product to be recommended. In the exemplary embodiment, m1:n1:p1:q1=6:4:5:5, in another exemplary embodiment, the ratio of m1, n1, p1 and q1 can be different from 6:4:5:5.

In the exemplary embodiment, the similarity score of the financial cycle can be the grade difference between the financial cycle of the focused product and the financial cycle of the product to be recommended. The grade of the financial cycle can be: the grade of current is recorded as 0 grade; if the financial cycle Y is less than 3, the grade is 1; if 3<Y≤6, the grade is 2; if 6<Y≤12, the grade is 3; if 12<Y≤36, the grade is 4; if 36<Y≤60, the grade is 5; if 60<Y, the grade is 6. The financial cycle Y is recorded by month; the maximum of the similarity score of the financial cycle is 100, the similarity score of the financial cycle is subtracted by 5 score for every 1 grade difference between the financial cycle of the focused product and the financial cycle of the product to be recommended. If the grade difference between the financial cycle of the focused product and the financial cycle of the product to be recommended is three, M=100−3*5=85.

The similarity score of the risk degree can be the grade difference between the financial cycle of the focused product and the financial cycle of the product to be recommended. The grade of the risk degree can be: low risk degree is recorded as 1; medium and low risk degree is recorded as 2; medium risk degree is recorded as 3; medium and high risk degree is recorded as 3; high risk degree is recorded as 5. The maximum of the similarity score of the risk degree is 100, the similarity score of the risk degree is subtracted by 5 score for every 1 grade difference between the risk degree of the focused product and the risk degree of the product to be recommended. If the grade difference between the risk degree of the focused product and the financial cycle of the product to be recommended is four, M=100−5*4=80.

The similarity score of the product type can be recorded as P and set to 100, when the type of the focused product is the same with the type of the product to be recommended, P=100, when the type of the focused product is different from the type of the product to be recommended, P=90.

The maximum of the similarity score of the yield rate is 100, the similarity score of the yield rate can be calculated according to the annual yield rate, the similarity score of the yield rate is subtracted by 1 score for every 0.1% difference between the annual yield rate of the focused product and the annual yield rate of the product to be recommended. If the difference between the annual yield rate of the focused product and the annual yield rate of the product to be recommended is 1.1%, the similarity score of the yield rate is recorded as Q, and Q=100−11=89.

It should be noted that, during the process of calculating the similarity scores corresponding to the financial cycle, the risk degree, the product type, and the yield rate, the specific values can be set according to the requirement, and cannot be limited to the described values.

In the exemplary embodiment, the predicted score of purchasing the product again for the customer to purchase the product to be recommended is calculated according to the similarity between the focused product and the product to be recommended and the operating data, such improving the accuracy rate of purchasing the product again for the customer to purchase the product to be recommended.

Furthermore, the present disclosure provides a method for recommending the product according to the third exemplary embodiment.

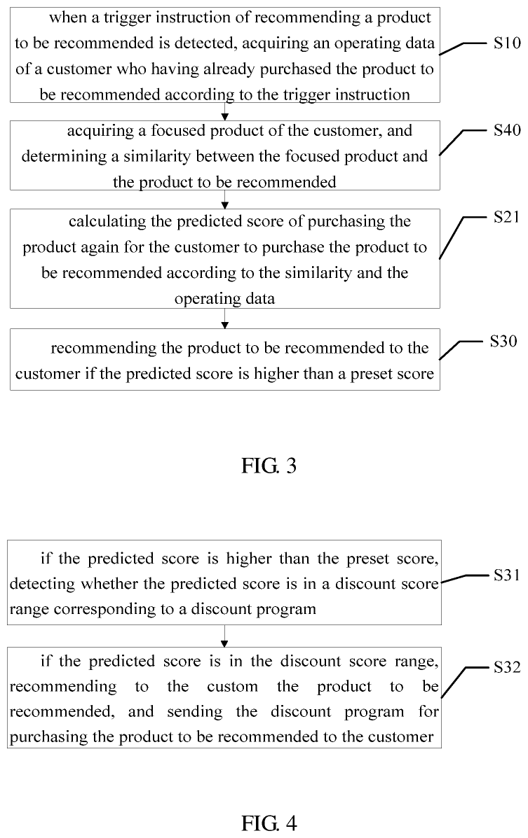

The difference between the method for recommending the product according to the third exemplary embodiment and the method for recommending the product according to the first exemplary embodiment is the step S30, referring to FIG. 4, the step S30 according to the third exemplary embodiment includes:

Step S31, if the predicted score is higher than the preset score, detecting whether the predicted score is in a discount score range corresponding to a discount program.

Step S32, if the predicted score is in the discount score range, recommending the product to be recommended to the customer, and sending the discount program for purchasing the product to be recommended to the customer.

When the predicted score is higher than the preset score, whether the predicted score is in the discount score range corresponding to the discount program is detected. When the predicted score is in the discount score range, the product to be recommended is recommended to the customer, and the discount program for purchasing the product to be recommended is sent to the customer simultaneously. The discount program and the discount score corresponding to the discount program are set according to the requirement, and are not limited in the exemplary embodiment of the present disclosure. If the predicted score is not in the discount score range, only the product to be recommended is recommended to the customer.

If the predicted score is set to 80, or higher than 80 (the discount score range can be 80 to 100), the customer can enjoy the discount program for purchasing the product to be recommended. If the product to be recommended is the financial product, each financial product has a minimum basic yield rate. When the basic yield rate of the product to be recommended is 3.5%, the basic yield rate can be set in different predicted score ranges to improve the yield rate. For example, when 80≤S<85, the yield rate is 3.55%; when 85≤S<90, the yield rate is 3.60%; when 90≤S<95, the yield rate is 3.65%; when 95≤S<100, the yield rate is 3.70%.

Through setting the discount program in the exemplary embodiment, when the customer meets the condition of the discount program, the product to be recommended is recommended to the customer, the discount program is sent to the customer simultaneously, which further improving the purchasing rate of the customer purchasing the product to be recommended, and improving the renewal rate of the renewed product.

In addition, the exemplary embodiment of the present disclosure also provides a device for recommending product, the device for recommending product includes:

an acquiring module, configured to, when detecting a trigger instruction of recommending a product to be recommended, acquire an operating data of a customer who having already purchased the product to be recommended according to the trigger instruction;

a calculating module, configured to calculate a predicted score of purchasing the product again for the customer to purchase the product to be recommended according to the operating data; and

a recommending module, configured to recommending the product to be recommended to the customer if the predicted score is higher than a preset score.

Furthermore, the acquiring module is also configured to acquire a product focused by the customer, and determine a similarity between the focused product and the product to be recommended;

the calculating module is also configured to calculate the predicted score of purchasing the product again for the customer to purchase the product to be recommended according to the similarity and the operating data.

Furthermore, when the focused product and the product to be recommended are both financial products, the acquiring module includes:

an acquiring unit, configured to acquire the product focused by the customer, and acquire a financial cycle, a risk degree, a product type, and a yield rate of the focused product; and

a determining unit, configured to respectively compare the financial cycle, the risk degree, the product type, and the yield rate of the focused product with a financial cycle, a risk degree, a product type, and a yield rate of the product to be recommended, to determine the similarity between the focused product and the product to be recommended.

Furthermore, the device for recommending product further includes:

a detecting module, configured to, when a login operation of logining into a corresponding application for purchasing the product to be recommended is detected, detect a clicking operation of the customer applied on the product in the application; and

the acquiring module is also configured to acquire the operating data of the customer operating the product in the application according to the clicking operation, and store the operating data.

Furthermore, the operating data includes a focus frequency of the customer to the product in the application, a payment data of the product in the application, a payment data corresponding to the purchased product, and click times of the product to be recommended.

Furthermore, the calculating module includes:

a first calculating unit, configured to respectively calculate predicted sub scores corresponding to the focus frequency, the payment data, the payment data and the click times according to corresponding preset rules, based on the focus frequency, the payment data, the payment data and the click times;

a determining unit, configured to determine weights of the focus frequency, the payment data, the payment data and the click times; and

the first calculating unit is also configured to calculate the predicted score of purchasing the product again for the customer to purchase the product to be recommended according to the predicted sub scores and the weights.

The weight of the focus frequency is 0.25, the weight of the payment data is 0.2, the weight of the payment data is 0.25, the weight of the click times is 0.3, when the predicted sub score of the focus frequency is recorded as A, the predicted sub score of the payment data is recorded as B, the predicted sub score of the payment data is recorded as C, the predicted sub score of the click times is recorded as D, the predicted score is recorded as S, then S=A*0.25+B*0.2+C*0.25+D*0.3.

Furthermore, the calculating module is also configured to calculate a difference value between total payment times and missed payment times in the payment data, and calculate the predicted sub score corresponding to the payment data according to the difference value and the total payment times.

Furthermore, the recommending module includes:

a detecting unit, configured to, if the predicted score is higher than the preset score, detect whether the predicted score is in a discount score range corresponding to a discount program; and

a recommending unit, configured to, if the predicted score is in the discount score range, recommend to the custom the product to be recommended, and send the discount program for purchasing the product to be recommended to the customer.

It should be noted that, the detail exemplary embodiments of the device for recommending product are substantially the same with the exemplary embodiments of the method for recommending product, no need to repeat again.

In addition, the exemplary embodiment of the present disclosure also provides a computer readable storage medium, which stores a program for recommending product, the program for recommending product performs the steps for realizing the method for recommending product when is executed by processor.

The detail exemplary embodiments of the computer readable storage medium are substantially the same with the exemplary embodiments of the method for recommending product, no need to repeat again.

It should be noted that, the persons skilled in the art can understand that all of the steps or parts of the steps for realizing the exemplary embodiments can be completed by hardware, or can be completed by related hardware instructed by program, the program can be stored in a computer readable storage medium, the storage medium can be a read-only memory, a magnetic disk, etc.

It should be noted that, in the present application, terms “include”, “comprise” and any other variants thereof are used to cover the non-excludability, so that processes, methods, goods or devices which include a series of elements may include not only these elements, but also other elements that shipping to list clearly, or inherent elements in the processes, the methods, the goods and the devices. In the absence of more restrictions, the elements defined by the statement “includes one . . . ” or other similar are not excluded from the processes, methods, goods or devices of the elements.

Sequence numbers of the forgoing embodiments of the present application are merely used for description and do not represent the advantages and disadvantages of the embodiments.

Through the above description of the embodiments, it is apparent to those skilled in the art that the above-mentioned embodiments may be implemented by software and a necessary universal hardware platform, of course, the hardware may also be used, but in many cases, the former is a better choice. According to this, an essence of the technical solution of the present application or a contribution to the prior technology may be reflected in a form of computer software products, the computer software products may be stored in a storage medium (such as an ROM/RAM, a magnetic disc, a light disc), a number of instructions are included for enabling a mobile terminal to perform the methods in each embodiment of the present application.

The foregoing description merely depicts some illustrative embodiments of the present application and therefore is not intended to limit the scope of the application. An equivalent structural or flow changes made by using the content of the specification and drawings of the present application, or any direct or indirect applications of the disclosure on any other related fields shall all fall in the scope of the application.

1. A method for recommending product, comprising the following steps:
when a trigger instruction of recommending a product to be recommended is detected, acquiring an operating data of a customer who having already purchased the product to be recommended according to the trigger instruction;
calculating a predicted score of purchasing the product again for the customer to purchase the product to be recommended according to the operating data; and
recommending the product to be recommended to the customer if the predicted score is higher than a preset score.

2. The method according to claim 1, wherein before the step of calculating a predicted score of purchasing the product again for the customer to purchase the product to be recommended according to the operating data, the method further comprises:
acquiring a focused product of the customer, and determining a similarity between the focused product and the product to be recommended;
the step of calculating a predicted score of purchasing the product again for the customer to purchase the product to be recommended according to the operating data comprises:
calculating the predicted score of purchasing the product again for the customer to purchase the product to be recommended according to the similarity and the operating data.

3. The method according to claim 2, wherein when the focused product and the product to be recommended are both financial products, the step of acquiring a focused product of the customer, and determining a similarity between the focused product and the product to be recommended comprises:
acquiring the focused product of the customer, and acquiring a financial cycle, a risk degree, a product type, and a yield rate of the focused product; and
respectively comparing the financial cycle, the risk degree, the product type, and the yield rate of the focused product with a financial cycle, a risk degree, a product type, and a yield rate of the product to be recommended, to determine the similarity between the focused product and the product to be recommended.

4. The method according to claim 1, wherein before the step of when a trigger instruction of recommending a product to be recommended is detected, acquiring an operating data of a customer who having already purchased the product to be recommended according to the trigger instruction, the method further comprises:
when a login operation of logining into a corresponding application for purchasing the product to be recommended is detected, detecting a clicking operation of the customer applied on the product in the application; and
acquiring the operating data of the customer operating the product in the application according to the clicking operation, and storing the operating data.

5. The method according to claim 4, wherein the operating data comprises a focus frequency of the customer to the product in the application, a payment data of the product in the application, a payment data corresponding to the purchased product, and click times of the product to be recommended.

6. The method according to claim 5, wherein the step of calculating a predicted score of purchasing the product again for the customer to purchase the product to be recommended according to the operating data comprises:
respectively calculating predicted sub scores corresponding to the focus frequency, the payment data, the payment data, and the click times according to corresponding preset rules, based on the focus frequency, the payment data, the payment data and the click times;
determining weights of the focus frequency, the payment data, the payment data, and the click times;
calculating the predicted score of purchasing the product again for the customer to purchase the product to be recommended according to the predicted sub scores and the weights; and
wherein, the weight of the focus frequency is 0.25, the weight of the payment data is 0.2, the weight of the payment data is 0.25, the weight of the click times is 0.3, when the predicted sub score of the focus frequency is recorded as A, the predicted sub score of the payment data is recorded as B, the predicted sub score of the payment data is recorded as C, the predicted sub score of the click times is recorded as D, the predicted score is recorded as S, then the predicted score S=A*0.25+B*0.2+C*0.25+D*0.3.

7. The method according to claim 6, wherein the step of calculating the predicted sub score corresponding to the payment data according to the preset rule corresponding to the payment data, based on the payment data, comprises:
calculating a difference value between total payment times and missed payment times in the payment data; and
calculating the predicted sub score corresponding to the payment data according to the difference value and the total payment times.

8. The method according to claim 1, wherein the step of recommending the product to be recommended to the customer if the predicted score being higher than a preset score comprises:
if the predicted score is higher than the preset score, detecting whether the predicted score is in a discount score range corresponding to a discount program; and
if the predicted score is in the discount score range, recommending to the custom the product to be recommended, and sending the discount program for purchasing the product to be recommended to the customer.

9. The method according to claim 2, wherein the step of recommending the product to be recommended to the customer if the predicted score being higher than a preset score comprises:
if the predicted score is higher than the preset score, detecting whether the predicted score is in a discount score range corresponding to a discount program; and
if the predicted score is in the discount score range, recommending to the custom the product to be recommended, and sending the discount program for purchasing the product to be recommended to the customer.

10. The method according to claim 3, wherein the step of recommending the product to be recommended to the customer if the predicted score being higher than a preset score comprises:
if the predicted score is higher than the preset score, detecting whether the predicted score is in a discount score range corresponding to a discount program; and
if the predicted score is in the discount score range, recommending to the custom the product to be recommended, and sending the discount program for purchasing the product to be recommended to the customer.

11. The method according to claim 4, wherein the step of recommending the product to be recommended to the customer if the predicted score being higher than a preset score comprises:
if the predicted score is higher than the preset score, detecting whether the predicted score is in a discount score range corresponding to a discount program; and
if the predicted score is in the discount score range, recommending to the custom the product to be recommended, and sending the discount program for purchasing the product to be recommended to the customer.

12. The method according to claim 5, wherein the step of recommending the product to be recommended to the customer if the predicted score being higher than a preset score comprises:
if the predicted score is higher than the preset score, detecting whether the predicted score is in a discount score range corresponding to a discount program; and
if the predicted score is in the discount score range, recommending to the custom the product to be recommended, and sending the discount program for purchasing the product to be recommended to the customer.

13. The method according to claim 6, wherein the step of recommending the product to be recommended to the customer if the predicted score being higher than a preset score comprises:
if the predicted score is higher than the preset score, detecting whether the predicted score is in a discount score range corresponding to a discount program; and
if the predicted score is in the discount score range, recommending to the custom the product to be recommended, and sending the discount program for purchasing the product to be recommended to the customer.

14. The method according to claim 7, wherein the step of recommending the product to be recommended to the customer if the predicted score being higher than a preset score comprises:
if the predicted score is higher than the preset score, detecting whether the predicted score is in a discount score range corresponding to a discount program; and
if the predicted score is in the discount score range, recommending to the custom the product to be recommended, and sending the discount program for purchasing the product to be recommended to the customer.

15. A device for recommending product, comprising one or more processors and a non-transitory program storage medium storing program code executable by the one or more processors, the program code comprising:
an acquiring module, configured to, when a trigger instruction of recommending a product to be recommended is detected, acquire an operating data of a customer who having already purchased the product to be recommended according to the trigger instruction;
a calculating module, configured to calculate a predicted score of purchasing the product again for the customer to purchase the product to be recommended according to the operating data; and
a recommending module, configured to, if the predicted score is higher than a preset score, recommending the product to be recommended to the customer.

16. The device according to claim 15, wherein the acquiring module is also configured to acquire a focused product of the customer, and determine a similarity between the focused product and the product to be recommended;
the calculating module is also configured to calculate the predicted score of purchasing the product again for the customer to purchase the product to be recommended according to the similarity and the operating data.

17. The device according to claim 16, wherein when the focused product and the product to be recommended are both financial products, the acquiring module comprises:
an acquiring unit, configured to acquire the focused product of the customer, and acquire a financial cycle, a risk degree, a product type, and a yield rate of the focused product; and
a determining unit, configured to respectively compare the financial cycle, the risk degree, the product type, and the yield rate of the focused product with a financial cycle, a risk degree, a product type, and a yield rate of the product to be recommended, to determine the similarity between the focused product and the product to be recommended.

18. The device according to claim 15, wherein the device further comprises:
a detecting module, configured to, when a login operation of logining into a corresponding application for purchasing the product to be recommended is detected, detect a clicking operation of the customer applied on the product in the application; and
the acquiring module is also configured to acquire the operating data of the customer operating the product in the application according to the clicking operation, and store the operating data.

19. An apparatus for recommending product, comprising a memory,
a processor, and a program for recommending product stored in the memory and operated by the processor, the program for recommending product performing following steps in a method for recommending product when being executed by the processor:
when a trigger instruction of recommending a product to be recommended is detected, acquiring an operating data of a customer who having already purchased the product to be recommended according to the trigger instruction;
calculating a predicted score of purchasing the product again for the customer to purchase the product to be recommended according to the operating data; and
recommending the product to be recommended to the customer if the predicted score is higher than a preset score.

20. (canceled)
